(19) United States
(12) Patent Application Publication
(10) Pub. No.: US 2014/0365670 A1
(43) Pub. Date: Dec. 11, 2014

(54) DISTRIBUTED DATA PROCESSING SYSTEM, DISTRIBUTED DATA PROCESSING METHOD AND WIRELESS TERMINAL POINT THEREOF

(71) Applicant: ACCTON TECHNOLOGY CORPORATION, HSINCHU (TW)

(72) Inventors: Te-An WANG, New Taipei City (TW); Chun-Sen SUN, New Taipei City (TW); Chung-Jen CHEN, New Taipei City (TW); Tan-Chun LU, New Taipei City (TW)

(73) Assignee: ACCTON TECHNOLOGY CORPORATION, HSINCHU (TW)

(21) Appl. No.: 14/045,804

(22) Filed: Oct. 4, 2013

(30) Foreign Application Priority Data
Jun. 5, 2013 (TW) 102119985

(51) Int. Cl. H04W 76/02

(52) U.S. Cl. CPC H04W 76/02
USPC 709/227

(57) ABSTRACT

A distributed data processing system, a distributed data processing method and a wireless terminal point thereof are disclosed, where the distributed data process system includes a first access controller, a plurality of second access controllers and a wireless terminal point (WTP). When receiving a list containing address information of the second access controllers from the first access controller, the WTP selects one of the second access controllers to serve as a designated second access controller and connects the designated second access controller.

### RELATED APPLICATIONS

This application claims priority to Taiwan Patent Application No. 102119985, filed Jun. 5, 2013, the entirety of which is herein incorporated by reference.

### BACKGROUND

1. Technical Field

The present disclosure relates to a network system, and more particularly, a distributed data processing system, a distributed data processing method and a wireless terminal point thereof.

2. Description of Related Art

The channels of control and provisioning of wireless access points (CAPWAP) can be classified into control channels and data channels. The data channel is responsible for the transmission of wireless frames between access controller (AC) and wireless terminal point (WTP). On the other hand, the control channel is responsible for the management between the access controller and the wireless terminal point for controlling and monitoring the exchange of messages.

The data channel of the CAPWAP may be operated under two schemes. In the first scheme, the packages received by the data channel are directly received and transmitted via the access controller (FIG. 1), and all payload data are forwarded via the access controller. In the second scheme, the wireless terminal point is set to use local bridging, and the access controller returns an address of an external device for transmitting data in a response of a control message. Further, the wireless terminal point transmits the data according to the address to the external device, so that it may be in direct communication with the external device without using the access controller (FIG. 2).

The first scheme can manage all packages received from or transmitted to the external environment, but, if the amount of packages to be processed is too large, the overall operation efficiency of the access controller may still decrease. In the second scheme, the packages on the data channel are directly received from or transmitted to the connected external device. Although it may lower the load of the access controller, the data are not monitored/managed by the access controller, and the packages from non-permitted or illegitimate client device may jeopardize the efficiency of the network or even result in unexpected impacts.

In view of the foregoing, there exist problems and disadvantages in the related art still unsolved. However, those skilled in the art sought vainly for a solution. There is an urgent need in the related field to improve the efficiency of data transmission and at the same time achieve effective data management.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one aspect, the present disclosure provides a distributed data processing system, a distributed data processing method and a wireless terminal point thereof, to overcome the problems which has faced the prior art.

According to one embodiment of the present disclosure, a distributed data processing system comprises a first access controllers, a plurality of second access controllers and at least one wireless terminal point. The wireless terminal point is configured to receive a list sent from the first access controller wherein the list comprises address information of the second access controllers, the wireless terminal point assigns one of the second access controllers as a designated second access controller from the list, and connects to the designated second access controller.

The wireless terminal point receives a connection request sent from a station, transmits a media access control address of the station to the first access controller, the first access controller determines that the station is permitted, and adds the media access control address into the designated second access controller, thereby allowing the designated second access controller to process data package transmitted from the station.

The wireless terminal point selects one of the second access controllers as the designated second access controller by sending a discovery request to one of the second access controllers, and assigning one of the second access controllers as the designated second access controller when one of the second access controllers responses.

The wireless terminal point assigns one of the second access controllers as the designated second access controller by sending a plurality of discovery requests to the second access controllers respectively, and assigning the second access controller that responses first as the designated second access controller accordingly.

The wireless terminal point is further configured to respectively send a plurality of discovery requests to the second access controllers respectively, and obtain an amount of wireless terminal points that each of the second access controllers processes according to responses of the second access controllers, wherein assigning one of the second access controllers as the designated second access controller is selecting the one that processes the least amount of wireless terminal points among the second access controllers as the designated second access controller.

According to one embodiment of the present disclosure, a distributed data processing method comprises the following steps: using a wireless terminal point to receive a list sent from a first access controller, wherein the list comprises address information of a plurality of second access controllers; using the wireless terminal point to assign one of a plurality of second access controllers from the list as a designated second access controller, and to connect to the designated second access controller.

The distributed data processing method further comprises the following steps: the wireless terminal point transmitting a media access control address of the station to the first access controller when receiving a connection request sent from a station; and the first access controller adding the media access control address into the designated second access controller when determining that the station is permitted, thereby allowing the designated second access controller to process data package transmitted from the station.

The step of assigning one of the second access controllers as the designated second access controller comprises following steps: using the wireless terminal point to send a discovery request to one of the second access controllers and to assign one of the second access controllers as designated second access controller when one of the second access controllers responses.

The step of assigning one of the second access controllers as the designated second access controller further comprises: using the wireless terminal point to send a plurality of discovery requests to the second access controllers respectively, and thereby assigning the second access controller that responses first as the designated second access controller.

The distributed data processing method further comprises: using the wireless terminal point to send a plurality of discovery requests to the second access controllers respectively; and obtaining an amount of wireless terminal points that each of the second access controllers processes according to responses of the second access controllers, wherein the step of assigning one of the second access controllers as the designated second access controller is selecting the one that processes the least amount of wireless terminal points among the second access controllers as the designated second access controller.

According to another embodiment of the present disclosure, a wireless terminal point comprises a transmitting unit and a processing unit. The transmitting unit is configured to receive a list sent from a first access controller wherein the list comprises address information of a plurality of second access controllers; the processing unit is configured to assign one of the second access controllers from the list as a designated second access controller, and to connect to the designated second access controller.

The transmitting unit receives a connection request sent from a station, the processing unit using the transmitting unit to transmit the media access control address of the station to the first access controller, the first access controller determines whether the station is permitted, the processing unit using the transmitting unit to add the media access control address into the designated second access controller, thereby allowing the designated second access controller to process data packages transmitted from the station.

The processing unit assigns one of the second access controllers as the designated second access controller by using the transmitting unit sending a discovery request to one of the second access controllers, and the processing unit assigns the one of the second access controllers as the designated second access controller when one of the second access controllers responses.

The processing unit assigns one of the second access controllers as the designated second access controller by using the transmitting unit respectively to send a plurality of discovery requests to the second access controllers respectively, and selecting the second access controller that responses first as the designated second access controller accordingly.

The processing unit further comprises: using the transmitting unit to send a plurality of discovery requests to the second access controllers respectively, and obtaining an amount of wireless terminal points that each of the second access controllers processes according to responses of the second access controllers, wherein the processing unit assigns one of the second access controllers as the designated second access controller by selecting the one that processes the least amount of wireless terminal points among the second access controllers as the designated second access controller.

In view of the foregoing, the technical solutions of the present disclosure result in significant advantageous and beneficial effects, compared with existing techniques. The implementation of the above-mentioned technical solutions achieves substantial technical improvements and provides utility that is widely applicable in the industry. Specifically, technical advantages generally attained, by embodiments of the present invention, include:

1. The payload of the first access controller is lowered, and the problems associated with data packages that are not under controlled are resolved; in this way, data offloading and data management are achieved at the same time; and

2. The designated second access controller could filter out data packages from illegitimate stations.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a schematic diagram illustrating the first scheme of the operation of the data channel of CAPWAP;

FIG. 2 is a schematic diagram illustrating the second scheme of the operation of the data channel of CAPWAP;

FIG. 3 is a block diagram illustrating a distributed data processing system according to one embodiment of the present disclosure;

FIG. 4 is a schematic diagram illustrating the transmission among various parties of a distributed data processing system according to one embodiment of the present disclosure;

FIG. 5 is a block diagram illustrating a wireless terminal point according to one embodiment of the present disclosure; and

FIG. 6 is a flow diagram illustrating a distributed data processing method according to one embodiment of the present disclosure.

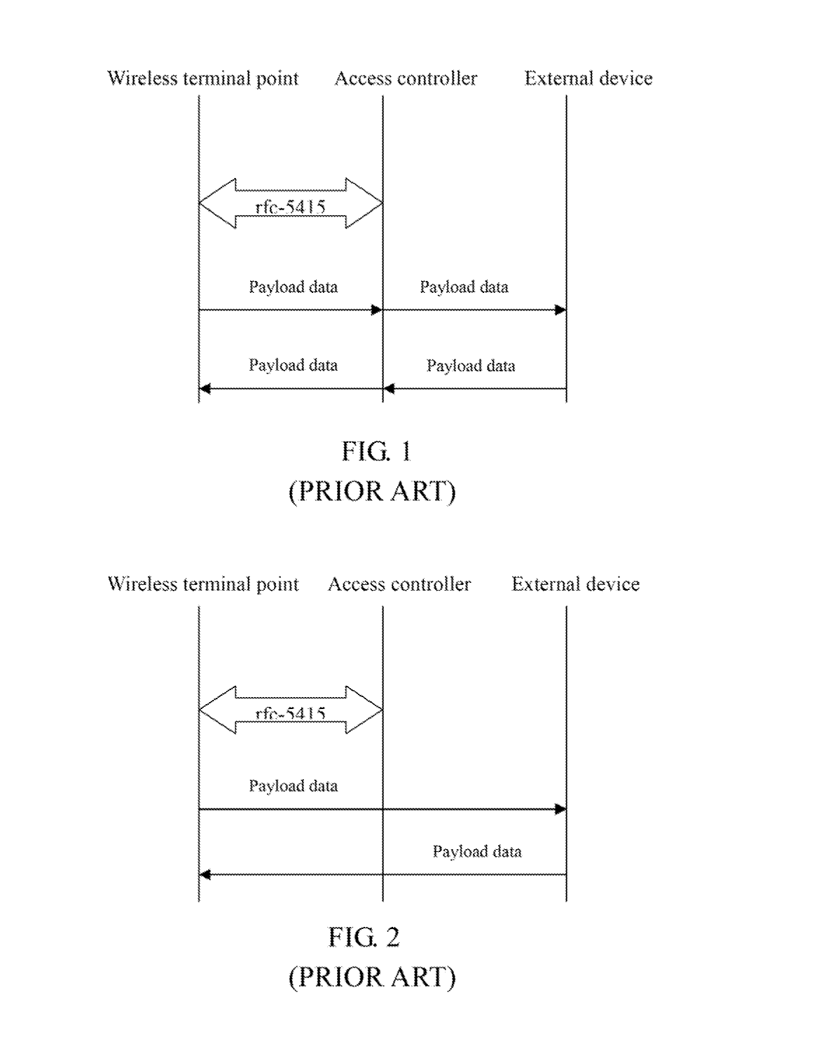

### DETAILED DESCRIPTION

In the following detailed description, for purposes of explanation, numerous specific details are set forth in order to attain a thorough understanding of the disclosed embodiments. In accordance with common practice, the various described features/elements are not drawn to scale but instead are drawn to best illustrate specific features/elements relevant to the present invention. Also, like reference numerals and designations in the various drawings are used to indicate like elements/parts. Moreover, well-known structures and devices are schematically shown in order to simplify the drawing and to avoid unnecessary limitation to the claimed invention.

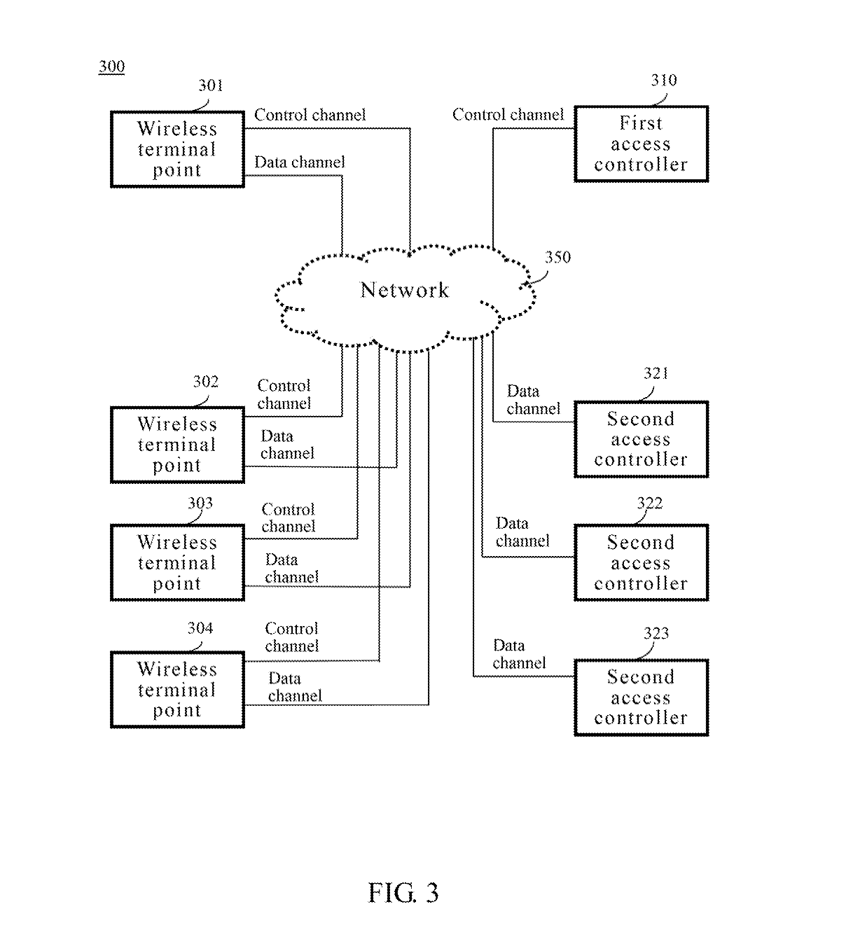

FIG. 3 is a block diagram illustrating a distributed data processing system 300 according to one embodiment of the present disclosure. As illustrated in FIG. 3, the distributed data processing system 300 comprises a first access controller 310, second access controllers 321-323 and wireless terminal points 301-304. In structure, the first access controller 310 establishes control channels with a plurality of wireless terminal points 301-304 via the network 350. In operation, the first access controller 310 sends a list that comprises address information of a plurality of second access controllers 321-323 to the wireless terminal points 301-304, each wireless terminal point is configured such that when it receives the list, one of a plurality of second access controllers 321-323 is assigned from the list as a designated access controller (e.g., the second access controller 321), and connects to the designated access controller 321 to establish the data channel. In this way, the first access controller 310 can use its full ability to process the vast arrangement and management of the wireless terminal points 301-304, and thereby reduces the loading of first access controller 310 and manages the package data.

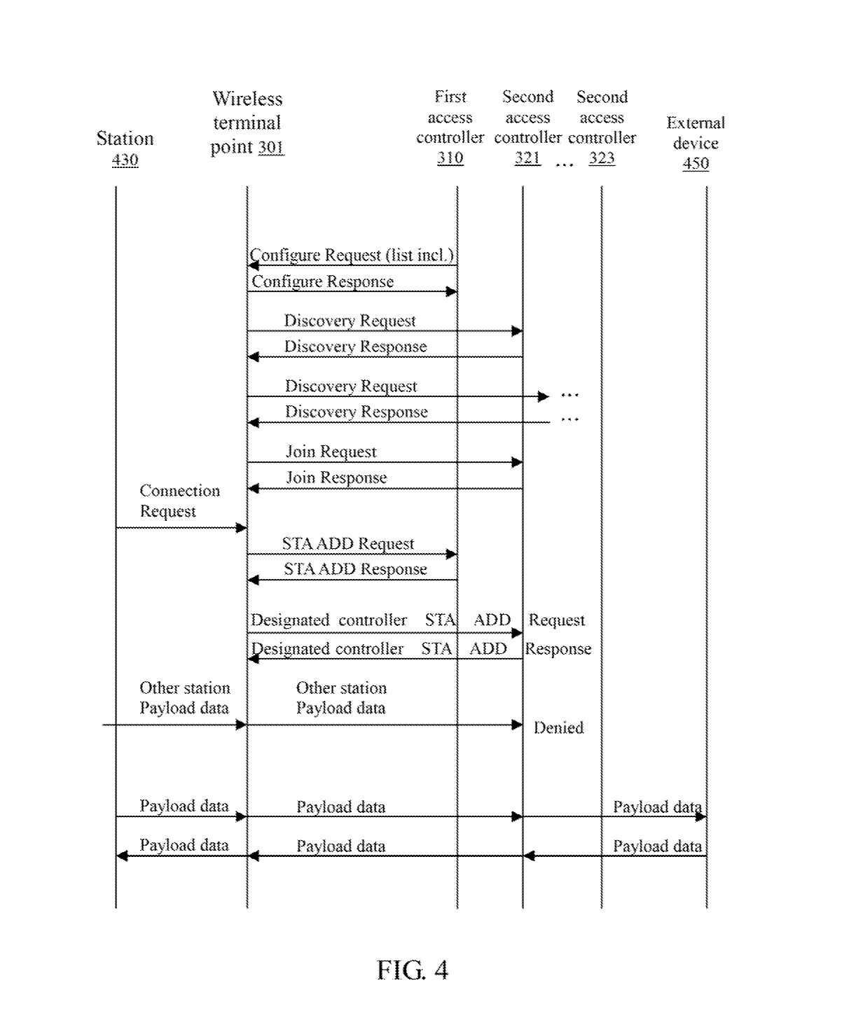

FIG. 4 is a schematic diagram illustrating the transmission among various parties of a distributed data processing system according to one embodiment of the present disclosure. In FIG. 4, the wireless terminal point 301 joins the first access controller 310 in accordance with the CAPWAP protocol, and after entering the run state, it send a message of a Configure Request from the first access controller 310 to the wireless terminal point 301, in which the Configure Request includes a list comprising address information of a plurality of second access controllers 321-323; and the wireless terminal point 301, after receiving said message, return a message of a Configure Response to notify the first access controller 310.

With respect to ways for assigning designated access controller, take the wireless terminal point 301 as an example, the wireless terminal point 301 sends a discovery request to one of the second access controllers 321-323 (for example, the second access controller 321), and when said one second access controller responses, assigns the said one second access controller 321 as the designated second access controller 321.

Alternatively, the wireless terminal point 301, after obtaining the list comprising address information of the second access controllers 321-323, according to the address information in the list (such as, IP and port), respectively sends a plurality of discovery requests to the second access controllers 321-323, and requests that the second access controllers 321-323 return a Discovery Response, so as to ensure that the second access controllers 321-323 are connectable. After the wireless terminal point 301 respectively sends a plurality of discovery requests to the second access controllers 321-323, the wireless terminal point 301 selects the second access controller (e.g., the second access controller 321) that responses first as the designated second access controller 321 so as to rapidly select the designated second access controller.

Still alternatively, the wireless terminal point 301 is configured to respectively send a plurality of discovery requests to the second access controllers 321-323, and according to responses of the second access controllers 321-323, obtain the amount of wireless terminal points processed by each of the second access controllers 321-323, and the wireless terminal point 301 selects, from the second access controllers 321-323, the one (e.g., the second access controller 321) that processes the least amount of wireless terminal points as the designated second access controller 321. In this way, it is feasible to avoid the uneven allocation of data size among second access controllers 321-323.

In view of the foregoing, after the wireless terminal point 301 assigns the designated second access controller 321 according to the above-discussed ways, the wireless terminal point 301 may once again send a message of Join Request to the designated second access controller 321, and after the wireless terminal point 301 receives a message of Join Response returned from the second access controller 321, it is confirmed that the joining is successful, and there exists a connection relationship between the wireless terminal point 301 and the designated second access controller 321.

In FIG. 4, the station 430 sends a connection request to the wireless terminal point 301; the content of the connection request includes the media access control address of the station 430 itself; after the wireless terminal point 301 receives the connection request, the media access control address of the station 430 is send as a message of “STA ADD Request” to the first access controller 310; the first access controller 310 will record this media access control address, and after a determination that the number of connections reaches an allowed number of connections or a default media access control list (MAC list), the determination result is returned as “STA add Response” to the wireless terminal point 301, thereby notifying the wireless terminal point 301 that the connecting station 430 is a device that is permitted or denied to be forwarded via the designated second access controller 321.

If the response of the first access controller 310 to the “STA ADD Request” indicates the permission of the forwarding, the wireless terminal point 301 uses a message of “Designated controller STA ADD Request” to notify the designated second access controller 321 of the data of the media access control address of the station 430, and after the designated second access controller 321 registers the media access control address, returns a message of “Designated controller STA ADD Response” to the wireless terminal point 301, the establishment of the data channel between the station 430 and the designated second access controller 321 is accomplished, and the designated second access controller 321 can process payload data (data package) transmitted from the station 430, and further forward it to the external device 450.

On the other hand, if another station sends the connection request to the wireless terminal point 301, the wireless terminal point 301 also sends a message of “STA ADD Request” representing media access control addresses of said another station to the first access controller 310; if the first access controller 310 responses a message of “STA ADD Request” indicating that the forwarding is denied, it means that the first access controller 310 discovers that the device requesting for connection is not from a station with an adequate media access control address; hence, it denies the forwarding of the message in the “STA ADD Request”; in this case, the designated second access controller 321 will not process the payload data transmitted from said another station, and will not forward it to the external device 450, hence, the present system framework can achieves data offloading and data management at the same time.

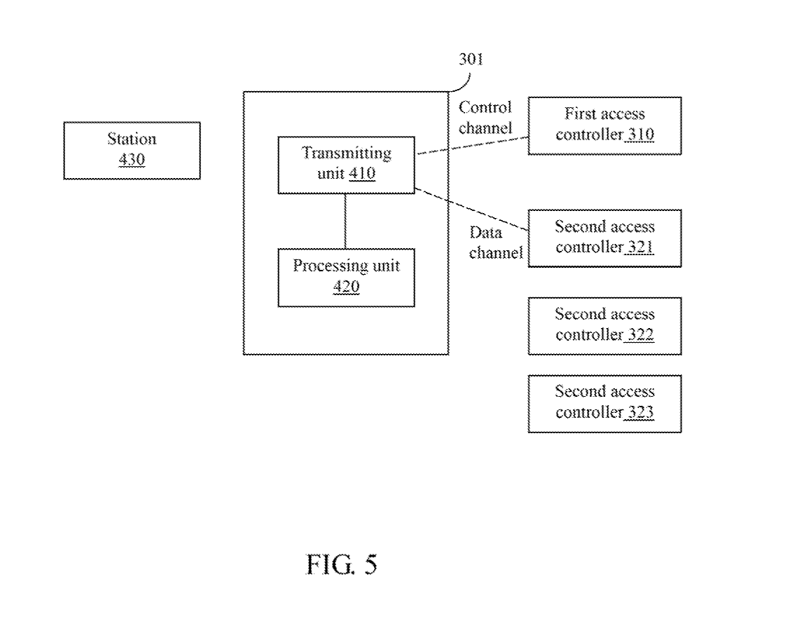

To further elaborate the above-discussed wireless terminal point, reference is made to FIG. 5, which is a block diagram illustrating a wireless terminal point according to one embodiment of the present disclosure. In FIG. 5, the wireless terminal point 301 is taken as an example, and the wireless terminal point 301 comprises a transmitting unit 410 and a processing unit 420. In structure, the transmitting unit 410 and the processing unit 420 are electrically connected. In operation, the transmitting unit 410 is configured to receive a list comprising address information of a plurality of second access controllers 321-323 which is sent from the first access controller 310; the processing unit 420 is configured to select one of a plurality of second access controllers 321-323 from the list as a designated second access controller 321, thereby allowing the transmitting unit 410 to connect to the designated second access controller 321.

When the wireless terminal point 301 receives the connection request sent from the station 430, it transmits the media access control address of the station 430 to the first access controller 310; when the first access controller 310 determines that the station is permitted, it adds the media access control address to the designated second access controller 321, thereby allowing the designated second access controller 321 to process the data package transmitted from the station 430. Conversely, when the first access controller 310 determines that the station 430 shall be denied, the station 430 is defined as an illegitimate station, and the designated second access controller 321 will not process the data package transmitted from the station 430. In this way, the designated second access controller 321 may filter out data package from illegitimate station(s).

Specifically, the transmitting unit 410, when receives the connection request sent from the station 430, the processing unit 420 transmits the media access control address of the station 430 to the first access controller 310 via the transmitting unit 410; when the first access controller 310 determines that the station 430 is permitted, the processing unit 420 adds the media access control address to the designated second access controller 321 via the transmitting unit 410, thereby allowing the designated second access controller 321 to process the data package transmitted from the station 430 (e.g., forwarding it to the external device). Conversely, when the first access controller 310 determines that the station 430 shall be denied, the processing unit 420 will not add the media access control address to the designated second access controller 321, thereby allowing the designated second access controller 321 to automatically filter out the data package transmitted from the station 430 instead of forwarding it to the external device.

In fact, in the WLAN environment, the station 430 generally can be a client device, a computer equipped with a wireless network interface card, or a smart phone with a WiFi module. The station 430 may be a mobile or fixed station. The wireless terminal point 310 can be a wireless access point configured to operate on the receiving and transmitting of wireless frames. The external device may be a web page server network switch device.

With respect to the assignment of the designated second access controller, as illustrated in FIG. 5, the processing unit 420 sends a discovery request to one (for example, the second access controller 321) of the second access controllers 321-323 via the transmitting unit 410, and when the second access controller 321 responses, assigns the second access controller 321 as the designated second access controller 321.

Alternatively, the processing unit 420, after the transmitting unit 410 respectively sends a plurality of discovery requests to the second access controllers 321-323, selects the second access controller (e.g., the second access controller 321) that responses first as the designated second access controller 321, so as to rapidly select the designated second access controller.

Still alternatively, the processing unit 420 further comprises: using the transmitting unit 410 configured to respectively send a plurality of discovery requests to the second access controllers 321-323, and according to responses of the second access controllers 321-323, obtaining the amount of wireless terminal points processed by each of the second access controllers 321-323, wherein processing unit 420 assigns, from the second access controllers 321-323, the one (e.g., the second access controller 321) that processes the least amount of wireless terminal points as the designated second access controller 321. In this way, it is feasible to avoid the uneven allocation of data size among second access controllers 321-323.

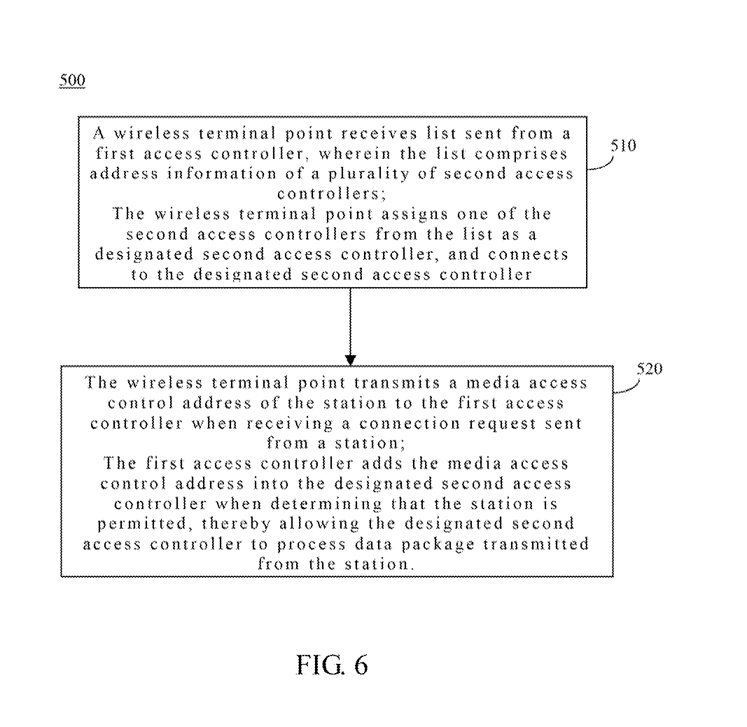

FIG. 6 is a flow diagram illustrating a distributed data processing method 500 according to one embodiment of the present disclosure. The distributed data processing method 500 is suitable for use in any wireless terminal point, or widely applied in other network apparatus. As illustrated in FIG. 6, the distributed data processing method 500 comprises steps 510-520. It should be appreciated that the steps are not recited in the sequence in which the steps are performed. That is, unless the sequence of the steps is expressly indicated, the sequence of the steps is interchangeable, and all or part of the steps may be simultaneously, partially simultaneously, or sequentially performed. Also, the hardware devices for implementing these steps have been specifically disclosed in the above embodiments, and hence, detailed description thereof is omitted herein for the sake of brevity.

In step 510, the wireless terminal point receives a list sent from the first access controller, wherein the list comprises address information of a plurality of second access controllers; the wireless terminal point assigns one of the second access controllers from the list as a designated second access controller, and connects to the designated second access controller, thereby establishing a data channel. In this way, the first access controller can use its full ability to process the vast arrangement and management of the wireless terminal points, and thereby reduces the loading of first access controller and manages the package data.

In step 520, the wireless terminal point, when receiving a connection request sent from the station, transmits the media access control address of the station to the first access controller; the first access controller, when determining that the station is permitted, adds the media access control address to the designated second access controller, thereby allowing the designated second access controller to process the data package transmitted from the station. Conversely, when the first access controller determines that the station shall be denied, the station is defined as an illegitimate station, and in step 520, the media access control address will not be added to the designated second access controller, thereby allowing the designated second access controller to automatically filter out the data package transmitted from the station. In this way, the designated second access controller 321 may filter out the data package from the illegitimate station.

With respect to the selection of the designated second access controller, in step 510, the wireless terminal point sends a discovery request to one of the second access controllers, and when said one second access controller responses, selects the same as the designated second access controller.

Alternatively, in step 510, the wireless terminal point, after respectively sending a plurality of discovery requests to the second access controllers, selects the second access controller that responses first as the designated second access controller, so as to rapidly select the designated second access controller.

Still alternatively, the distributed data processing method 500 further comprises: using the wireless terminal point to respectively send a plurality of discovery requests to the second access controllers, and according to responses of the second access controllers, obtaining the amount of wireless terminal points processed by each of the second access controllers; in step 510, selecting, from the second access controllers, the one that processes the least amount of wireless terminal points as the designated second access controller. In this way, it is feasible to avoid the uneven allocation of data size among second access controllers.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A distributed data processing system, comprising:
a first access controller;
a plurality of second access controllers; and
at least one wireless terminal point, configured to receive a list sent from the first access controller, wherein the list comprises address information of the second access controllers, the wireless terminal point assigns one of the second access controllers as a designated second access controller from the list, and connects to the designated second access controller.

2. The distributed data processing system according to the claim 1, wherein the wireless terminal point receives a connection request sent from a station, transmits a media access control address of the station to the first access controller, the first access controller determines that the station is permitted, and adds the media access control address into the designated second access controller, thereby allowing the designated second access controller to process data package transmitted from the station.

3. The distributed data processing system according to the claim 1, wherein the wireless terminal point selects one of the second access controllers as the designated second access controller by sending a discovery request to one of the second access controllers, and assigning one of the second access controllers as the designated second access controller when one of the second access controllers responses.

4. The distributed data processing system according to the claim 1, wherein the wireless terminal point assigns one of the second access controllers as the designated second access controller by sending a plurality of discovery requests to the second access controllers respectively, and assigning the second access controller that responses first as the designated second access controller accordingly.

5. The distributed data processing system according to the claim 1, wherein the wireless terminal point is further configured to send a plurality of discovery requests to the second access controllers respectively, and obtain an amount of wireless terminal points that each of the second access controllers processes according to responses of the second access controllers,
wherein assigning one of second access controllers as the designated second access controller is selecting the one that processes the least amount of wireless terminal points among the second access controllers as the designated second access controller.

6. A distributed data processing method, comprising the following steps of:
using a wireless terminal point to receive a list sent from a first access controller, wherein the list comprises address information of a plurality of second access controllers; and
using a wireless terminal point to assign one of the second access controllers from the list as a designated second access controller, and to connect to the designated second access controller.

7. The distributed data processing method according to the claim 6, further comprising the steps of:
the wireless terminal point transmitting a media access control address of the station to the first access controller when receiving a connection request sent from a station; and
the first access controller adding the media access control address into the designated second access controller when determining that the station is permitted, thereby allowing the designated second access controller to process data package transmitted from the station.

8. The distributed data processing method according to the claim 6, wherein the step of assigning one of the second access controllers as the designated second access controller further comprises following steps:
using the wireless terminal point to send a discovery request to one of the second access controllers, and to assign one of the second access controllers as the designated second access controller when one of the second access controllers responses.

9. The distributed data processing method according to the claim 6, wherein the step of assigning one of the second access controllers as the designated second access controller further comprises:
using the wireless terminal point to send a plurality of discovery requests to the second access controllers respectively, and thereby assigning the second access controller that responses first as the designated second access controller

10. The distributed data processing method according to the claim 6, further comprising:
using the wireless terminal point to send a plurality of discovery requests to the second access controllers respectively; and
obtaining an amount of wireless terminal points that each of the second access controllers processes according to responses of the second access controllers,
wherein the step of assigning one of the second access controllers as the designated second access controller is selecting the one that processes the least amount of wireless terminal points among the second access controllers as the designated second access controller.

11. A wireless terminal point, comprising:
a transmitting unit, configured to receive a list sent from a first access controller, wherein the list comprises address information of a plurality of second access controllers; and
a processing unit, configured to assign one of the second access controllers from the list as a designated second access controller, and to connect to the designated second access controller.

12. The wireless terminal point according to the claim 11, wherein the transmitting unit receives a connection request sent from a station, the processing unit uses the transmitting unit to transmit the media access control address of the station to the first access controller, the first access controller determines that the station is permitted, the processing unit uses the transmitting unit to add the media access control address into the designated second access controller, thereby allowing the designated second access controller to process data package transmitted from the station.

13. The wireless terminal point according to the claim 11, wherein the processing unit assigns one of the second access controllers as the designated second access controller by using the transmitting unit to send a discovery request to one of the second access controllers, and the processing unit assigns one of the second access controllers as the designated second access controller when one of the second access controllers responses.

14. The wireless terminal point according to the claim 11, wherein the processing unit assigns one of the second access controllers as the designated second access controller by using the transmitting unit to send a plurality of discovery requests to the second access controllers respectively, and selecting the second access controller that responses first as the designated second access controller accordingly.

15. The wireless terminal point according to the claim 11, wherein the processing unit further comprises: using the transmitting unit to send a plurality of discovery requests to the second access controllers respectively, and obtaining an amount of wireless terminal points that each of the second access controllers processes according to responses of the second access controllers, wherein the processing unit assigns one of the second access controllers as the designated second access controller by selecting the one that processes the least amount of wireless terminal points among the second access controllers as the designated second access controller.
